(19) United States
(12) Patent Application Publication
(10) Pub. No.: US 2025/0139562 A1
(43) Pub. Date: May 1, 2025

(54) DYNAMIC PEER GROUPS FOR BENCHMARKING

(71) Applicant: SAP SE, Walldorf (DE)

(72) Inventors: Gregor Berg, Walldorf (DE); Carsten Henning Bormann, Walldorf (DE); Shakhlo Ismailova, Walldorf (DE); Karolin Stefani, Walldorf (DE); Alexander Cramer, Walldorf (DE)

(21) Appl. No.: 18/497,037

(22) Filed: Oct. 30, 2023

(51) Int. Cl. G06Q 10/0639; G06F 3/04812

(52) U.S. Cl. CPC G06Q 10/06393; G06F 3/04812

(57) ABSTRACT

Provided is a system and method for filtering data records via user interaction on a user interface. During the filtering process, the user interface can provide insights into the next filtering step by displaying additional insight on the user interface. In one example, the method may include displaying a user interface comprising interactive controls, receiving a selection of a filtering condition based on input on the user interface, in response to the selection, filtering a plurality of data records based on the selected filtering condition to identify a subset of data records that satisfy the filtering condition from among the plurality of data records, identifying a subset of filtering conditions from among the plurality of filtering conditions that are available for the subset of data records, and displaying an identifier of the subset of data records and identifiers of the subset of filtering conditions on the user interface.

### BACKGROUND

Many organizations rely on software to run their business such as enterprise resource planning (ERP) software. ERP helps companies create and track orders, generate and clear invoices, receive payments, interact with a website, and the like. ERP software also offers opportunities to perform process mining on the business process.

Process mining is a technique that provides insight about a business process to an organization. In many cases, process mining includes executing algorithms on log data from a runtime environment of the business process to identify trends, patterns, variants and other details of the process and how it unfolds. The result of the processing mining is a graph (i.e., a diagram) that represents events within the process using elements in the diagram. The diagram usually provides the viewer with an understanding of how their own process performs without much insight into how to make it better. However, simply providing an organization with a process graph that explains their process does not provide much insight to the organization on how their process performs with respect to other processes in the industry. As a result, there is not much insight that can be gained from a process graph.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 is a diagram illustrating a process of benchmarking a target process based on a reference process in accordance with example embodiments.

FIGS. 2A-2D are diagrams illustrating a process of benchmarking a target process and creating suggested improvements to the target process based on a reference process in accordance with example embodiments.

FIG. 3 is a diagram illustrating partially overlapping data sets that are capable of being filtered together in accordance with example embodiments.

FIGS. 4A-4C are diagrams illustrating a process of identifying a dynamic peer group in accordance with example embodiments.

FIG. 5A-5B are diagrams illustrating a process of generating and illustrating filtering metadata for a next iteration of the dynamic peer group selection in accordance with example embodiments.

FIG. 6 is a diagram illustrating a view of lead time from a benchmarking group in accordance with example embodiments.

FIG. 7 is a diagram illustrating a method of controlling a record filtering process via a user interface in accordance with example embodiments.

FIG. 8 is a diagram illustrating a computing system for use in the examples herein in accordance with example embodiments.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown but is to be accorded the widest scope consistent with the principles and features disclosed herein.

Process mining is an analysis method that helps organizations improve the way that they run their business. The result of a process being mined is a graph diagram that visualizes the process. Traditional process mining methods merely provide descriptive analysis of the process within the diagram. If action recommendations are provided at all, they are typically provided based on rules that are hardcoded into the process mining software. Furthermore, the process diagram provides little insight into how an organization can make their process better.

In the examples below, a software system (also described herein as a host system) provides a suite of software that can generate a process diagram, such as those traditionally generated from process mining, using document data instead of runtime process data. The system can build a custom process diagram (e.g., graph) with nodes representing events or activities within the process and edges between the nodes representing a flow/execution dependencies among the events. Furthermore, the edges can be annotated with additional attributes of the process such as the average amount of execution time that it takes between two events, etc.

However simply generating a custom process diagram still does not provide an owner/developer of the process with an understanding of how other processes in a similar field are performing the process in a different and improved manner. According to various embodiments, the host system may generate additional insight into a process by externally “benchmarking” the customer's process against a reference process diagram of another organization or group of organizations. The reference process diagram can be constructed from best-in-class process versions based on a common reference model. The reference model may be a maximum version of the process (all possible steps) while a customer has a subset of the maximum version. The comparison can visually show the organization what steps are different in the customer's process versus the reference process based on the processes of other companies that are “external” to the customer thereby allowing the customer's process to be externally benchmarked.

Through the benchmarking process, the organization can visually see and understand how other process versions in the same field/business area are performing the process and what steps they are doing differently. For example, if another entity is performing a similar process for similar reasons but with less execution time, the host system may identify which steps are causing the slower execution time in the target process and make suggestion on how to improve these steps. The steps may be extracted from the reference diagram and used to define changes to perform to create a target process. By benchmarking the target process using data from process versions of other customers (i.e., external benchmarking), the example embodiments can provide helpful insight to process owners, department heads or developers of the software with actions and other process steps that can improve the execution of their own process.

One of the difficulties with the benchmarking process is identifying other organizations to use for the reference model. For example, a company with 90% of its revenue coming from the sales of running shoes may assume it should benchmark itself against another well-known shoe company oblivious the fact that the other well-known shoe company makes 75% of its revenue from the sale of golf equipment. Selecting the wrong peers or peer group can result in a benchmarking process and insights that are too generic and less trustworthy.

The example embodiments provide a filtering system with an interactive user interface that helps guide a user to select a peer group for the purposes of benchmarking. For example, the filtering system can filter data records (of organizations) based on dynamically selected filtering features that are relevant to a target organization. The filtering system includes an interactive user interface that enables a user to dynamically select search parameters and values for these search parameters. The filtering system can then compare the dynamically selected parameters and values to values stored in the data records of other organizations to identify organizations that best match the search criteria chosen. These organizations, and their processes, can be used for benchmarking since these will provide the most relevant comparisons. It should also be appreciated that the filtering system described herein may be used for other features besides benchmarking. For example, anytime an organization wants to compare itself to other organizations, the filtering system can be helpful.

The parameters that are used to compare the target organization to the peer organizations may include parameter values that are not well known to the target organization but which are highly relevant for comparing two businesses together. For example, parameters such as total revenue, number of employees, number of customers, procurement spending, lead generation spending, and the like, may be much more relevant to determining the similarity of the target organization to a peer organization for process benchmarking purposes than a type of product that is offered by the target organization and a type of product offered by the peer organization(s).

In some embodiments, the filtering process can be used to select a final subset of peers (e.g., 1-5, etc.) from among a much larger set of peers. Due to local, regional or national restrictions of data usage, these peers must remain anonymous and benchmarking can only be performed if a minimum amount of organizations are part of the peer group to avoid singling out one specific organization. The process diagrams of the selected peers can then be used to construct a reference diagram with all possible steps from the process diagrams of the peers. The reference model can be thought of as a complete picture of the process type including all possible known (i.e., defined) steps used by the other processes and the directed edges between these displaying the flow of the process. The host system may generate multiple reference models for different types of processes. The processes may be business processes, sales processes, ordering processes, delivery process, etc.

During the benchmarking process, the host system may compare the process diagram of a target process (target organization) to a reference diagram (of a reference process generated from the dynamically selected peers) and identify changes that can be made to the target process to improve the target process based on the reference diagram. In addition, the host system can visually show these changes within the process diagram of the target process thereby visually showing the owner/developer of the process the changes that can be made to improve the process based on the best-practices of the industry. That is, the host system can provide a process overview as well as recommendations on how to fix/improve the process based on how other entities and organizations are performing the same process in a more efficient manner. An example of a benchmarking system and process are described in U.S. patent application Ser. No. 18/473,505, filed on Sep. 25, 2023, in the United States Patent and Trademark Office which is fully incorporated herein by reference for all purposes.

The events or activities within a process that are described herein may refer to milestones or blockers. For example, a business process that involves the sale of goods may include a requirement that a sales order (document) be created which identifies the goods and a requirement that an invoice (document) be generated and cleared. These three actions can be considered milestones. For example, the first milestone may be “creating a sales order”, a second milestone may be “creating an invoice”, and a third milestone may be “clearing the invoice”. As another example, blockers are occurrences or events that block the process from moving forward and will usually remain in place until the block is removed, if they don't directly terminate the process instance (e.g., the manual cancelation of an order).

Such standardized milestones and blockers have been and can be identified from years of expertise in the field of process insights and avoid unnecessary mining projects which attempt to mine the entire state space of the process including parts of the process that are unrelated to the ultimate success of the process. While process mining can give you the whole state space including all irrelevant variants, paths and events, the example embodiments focus on identifying the standard blockers typically encountered by most businesses and the paths chosen to remedy these blockers. From a commercial perspective, the customer does not have to decide on one process to understand in depth but can get insights into challenges and blockers in a standardized way across the whole process landscape. The software system may provide pages of user interfaces which enable users to choose or otherwise select a subset of milestones from the predefined/standardized list and a subset of blockers for each milestone from another predefined/standardized list.

The data for identifying the insights can be extracted from process data stored in an underlying data store/database, for example, sales data, sales orders, invoices, payment transactions, account summaries, and the like, which can be used to see how the process is performing. To do this, the host system may query the process data and generate insights according using the systems and methods described in U.S. patent application Ser. No. 18/118,857, filed on Mar. 13, 2023, in the United States Patent and Trademark Office, the entire disclosure of which is fully incorporated herein by reference for all purposes.

In some embodiments, the process insights may be stored in a table or other data structure that can be analyzed by the host system to identify a list of events that occur during the process. Details of the events may be recorded in an event log such as a table or other structure. Furthermore, the host system can insert “virtual” events into the event log which are not found in the raw data but can be inferred from the other events that are found in the event log. The event log may include enough detail to build a process diagram (e.g., a graph) using existing process mining algorithms. The resulting process diagram may include a plurality of nodes that represent the plurality of milestones of the process, and/or other events that occur within the process. The nodes may include edges in-between which illustrate the “flow” of the process between the milestones and/or events. The flow may include directional edges, and annotations on the directional edges which include runtime attributes of the process such as completion percentage between two steps, average execution times, distribution between different succeeding edges and the like.

The host system may analyze the process diagram to provide the customer with intelligence associated with their target process. For example, the host system may identify performance attributes of the target process over time including what percentage of users reach each milestone, what percentage of users follow different paths within the process diagram, an order among the different steps in the process, and the like. The host system may also compare the performance attributes of the process to performance attributes of other processes that are of similar type. For example, the host system may compare a process diagram of a customer's process to a reference diagram (e.g., a process model) that is generated based on other process implementations of other customers that are of similar type. Here, the host system may overlay the reference diagram of the reference process on top of a diagram of the target process to visualize the different flows between the two processes such as differences in steps performed including extra steps in the reference process and steps omitted from the reference process. Furthermore, the host system may analyze metadata associated with flows such as timing, delays, other steps available, etc. to identify which steps can be used to improve the target process and recommend suggestions on how to improve the target process based on alternative process steps identified from the reference diagram.

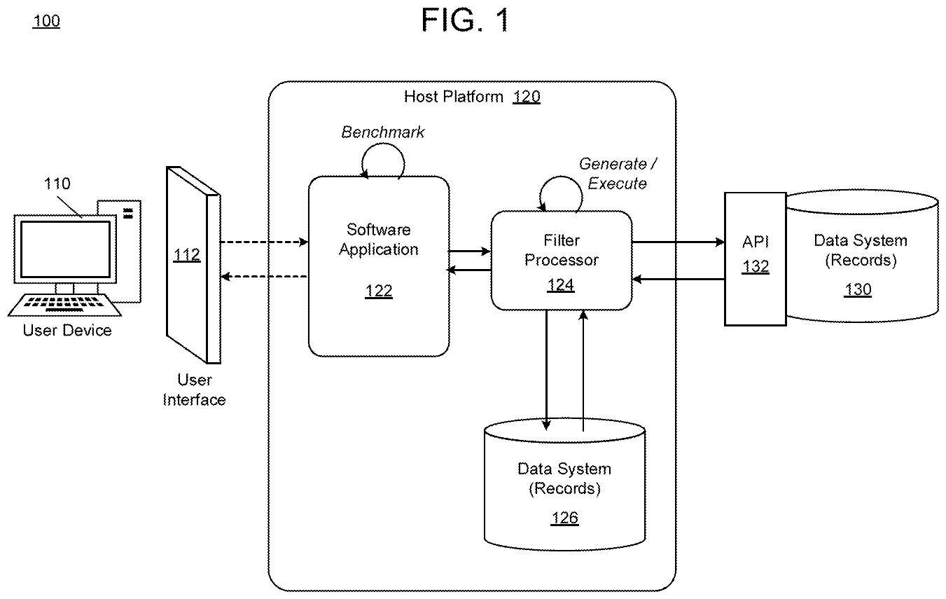

FIG. 1 illustrates a computing environment 100 of a host platform 120 for benchmarking a target process in accordance with an example embodiment. Referring to FIG. 1, the host platform 120 may be a cloud platform, a web server, a database, a combination of devices, and the like. The host platform 120 hosts a software application 122 for benchmarking. The software application may include one or more analytic programs that can analyze a business process and generate a benchmark of the process based on a reference process that contains the best practices of the process type. The data used by the software application 122 to benchmark the process may be stored in a data system, for example, data system 126 that is local to the host platform and/or data system 130 that is external to the host platform 120 and that is accessible via a network such as the Internet. As described herein, a data system may refer to a database, a website, a data service, a blockchain, or the like. The data system 126 may be accessed via an API and/or it may be accessed via a query such as a SQL query, or the like.

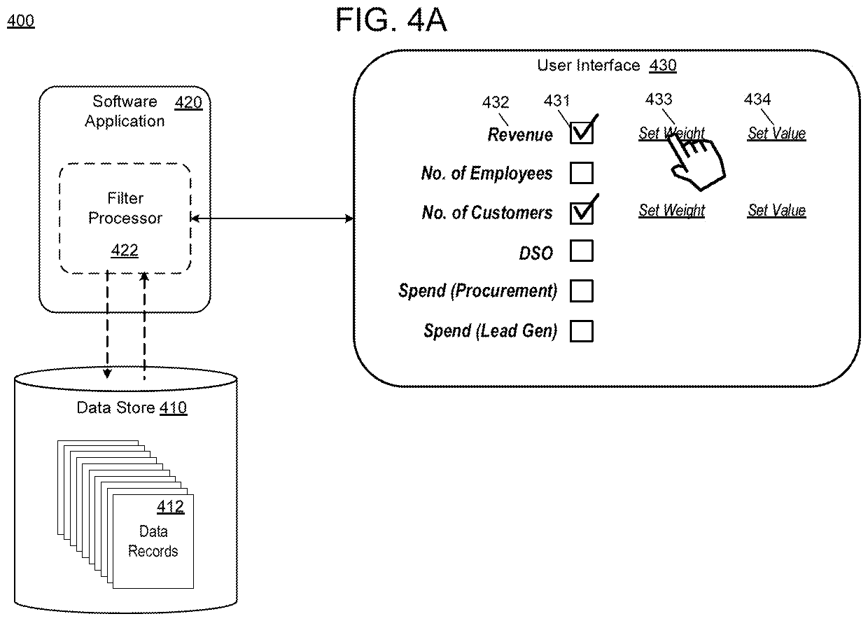

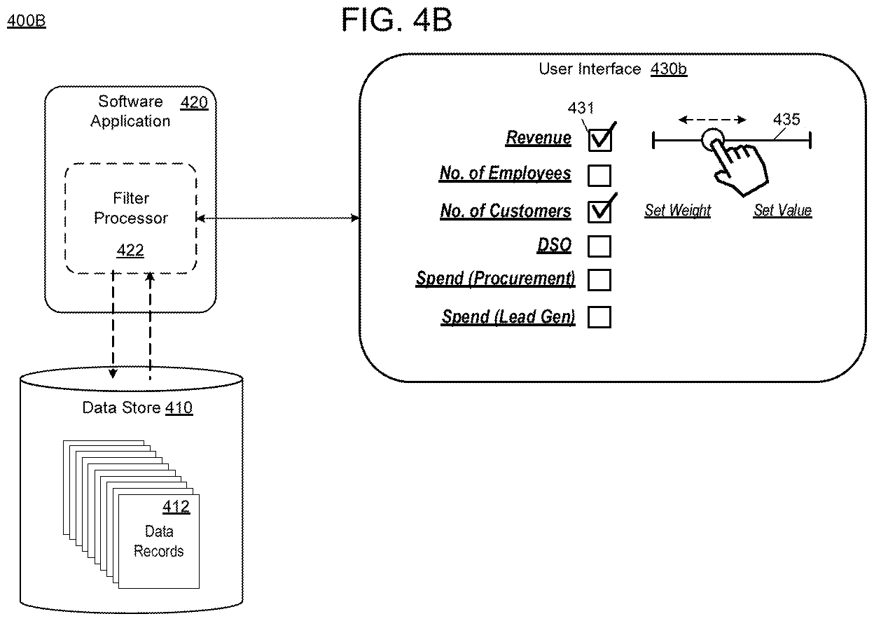

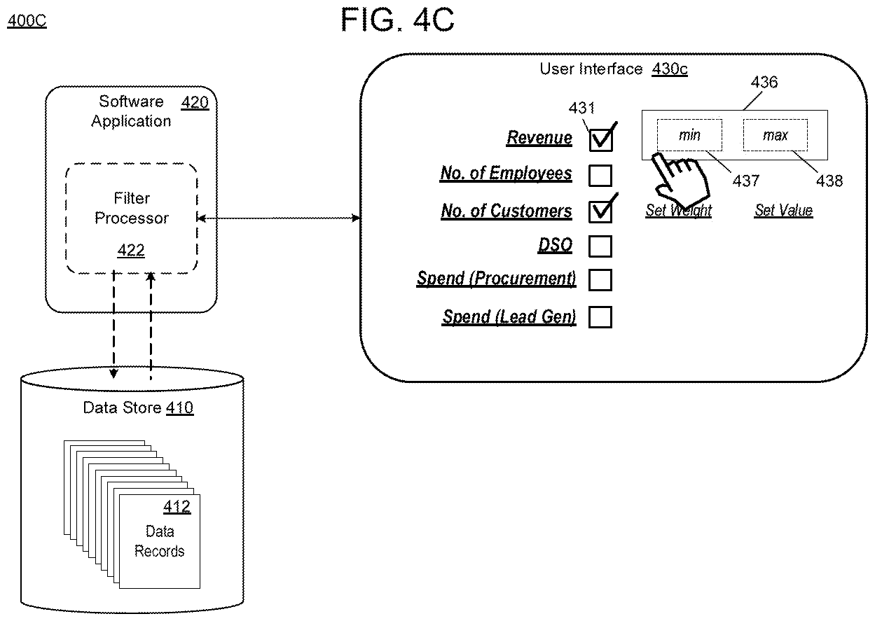

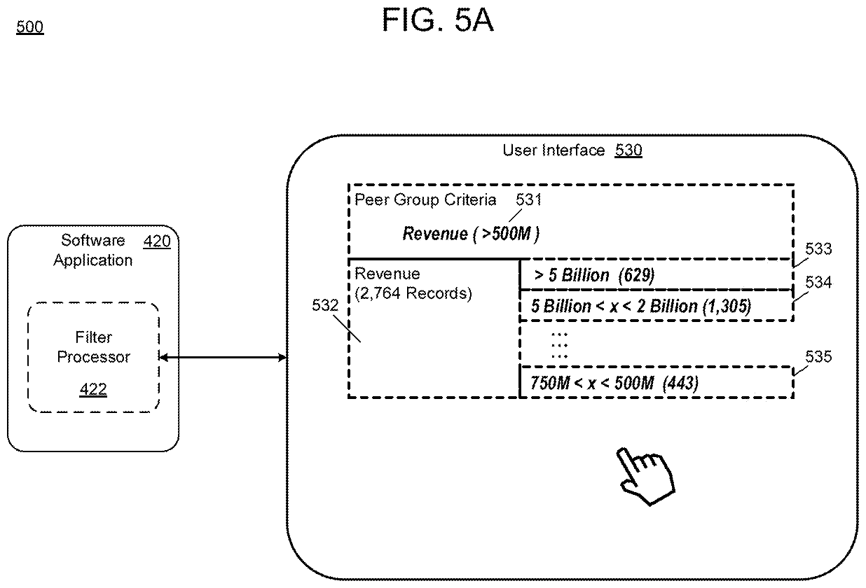

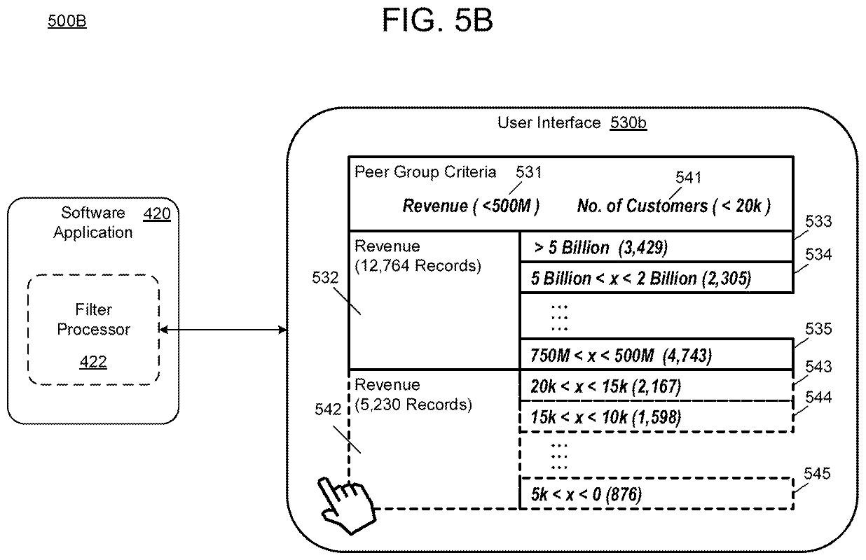

In this example, a user such as a process expert may interact with the software application 122 via a user device 110 such as a laptop computer, a mobile device, a desktop computer, a server, and the like. For example, the user may use the user device 110 to connect to a website, uniform resource locator (URL), or other location where the software application 122 is hosted. In some examples, the software application 122 is a progressive web application, a mobile application, or the like. In some embodiments, the software application 122 is actually a suite of multiple applications. The software application 122 may include a front-end with a user interface 112 that is output on a screen/display of the user device 110 once a session is established between the user device 110 and the host platform 120. The user interface 112 may include controls which can be used to filter data records that are stored in the data system 126 and/or the data system 130. Examples of the filtering are further described in the examples of FIGS. 4A-4C and 5A-5B.

According to various embodiments, the user may input search criteria (e.g., filtering conditions, etc.) into the user interface 112 which are submitted to the software application 122 and executed on at least one of the data system 126 and the data system 130 by a filter processor 124 such as a query processor, etc. In this example, the data system 130 is accessed via an application programming interface (API) such as API 132. The software application 122 may output guidance for the user via the user interface 112 to assist the user in selecting the correct system. A schema of the selected system may be uploaded to the software application 122 via the user interface 112. For example, the user may upload a file, a document, a spreadsheet, or the like which includes the schema information.

The software application 122 may also provide various user interfaces which enable the user to define milestones within the process and blockers for those milestones. The user interfaces may be accessible via a same page of the software application 122 or across multiple different pages of the software application 122. The user may also define a script or other instructions with query commands for querying the data necessary for analyzing the milestones and blocker(s) of the milestone via the user interface. Each blocker may have its own query, for example, a structured query language (SQL) query, or the like. The software application 122 may provide user interfaces and standardized lists of milestones and blockers (e.g., via drop-down menus, etc.) that the user can select from. Furthermore, software application 122 may also provide support and assistance in developing queries for accessing the data from the underlying data system.

When all queries for all blockers have been generated, the software application 122 may create a single script, API call, etc., which can be executed by the filter processor 124 on the selected data system to retrieve remove data records from the search process and identify attributes of remaining data records after the filtering. For example, the software application 122 may generate a structured query language (SQL) query for each of the blockers and then create a single script which extracts a union of all of the fields necessary from the data system. Furthermore, the software application 122 may analyze the remaining data records performed after the filtering to identify additional filtering options that can be performed on the remaining subset of records. For example, the software application 122 may analyze the records and identify parameters that can be used to further filter the subset of records. Here, the software application 122 may display identifiers of the available filtering parameters on the user interface 112. In some embodiments, the data system may also include an API, such as data system 130 which includes an API 132. In this example, the query generated by the software application 122 may include query commands and/or API calls for extracting or pushing the process data from the data system 130.

The generated script, query, etc. may be stored by the software application 122 and accessed by the user via the user device 110 or any other user with access to the process data via the software application 122. Here, the user may provide an identifier of the process (e.g., a process ID, etc.). In response, the software application 122 may query the selected data system based on the previously generated query corresponding to the process ID, and execute one or several analytic queries on the process data to generate insights about the process which can be displayed on the user interface 112. The process insights may include identifiers of milestones (e.g., events, activities, etc.) within the process and any blockers associated with the milestones. In addition, the insights may include context associated with the milestones and blockers such as how many users/customers are affected by the blockers, how many customers/users fail to finish the process, where customers are getting stuck in the process, and the like.

The process data that is pulled/extracted from the data systems 126 and 130 may include values of table data that are queried from tables stored in therein including order data, invoice data, payment data, shipping data, transportation data, inventory data, and the like. Through this data, the software application 122 can analyze the process data to identify insights associated with the process. For example, the software application 122 may identify how long it takes for each milestone to be reached (e.g., the amount of time that elapses between milestones) and the blockers that block these milestones from being achieved. To identify the duration between milestones, the software application 122 may use timestamps of when the process enters the two respective milestones on average and subtract the two.

When the process diagram has been created, the host system may select a reference diagram of the process and analyze it for additional insights. The reference diagram may be generated in advance and may include a sequence of steps that are best-practices in the industry for that type of process. The reference diagrams can be generated by users, generated by analysis, or the like. Here, the host system may compare the process diagram to the reference diagram to provide additional insight about how to improve the target process shown in the process diagram. Furthermore, the reference diagram identified through a unique filtering process that is further described herein. In particular, key performance indicators (KPIs) may be used as filter criteria to identify “similar” organizations that are equivalent to a target organization based on underlying performance, and not based on the products they sell.

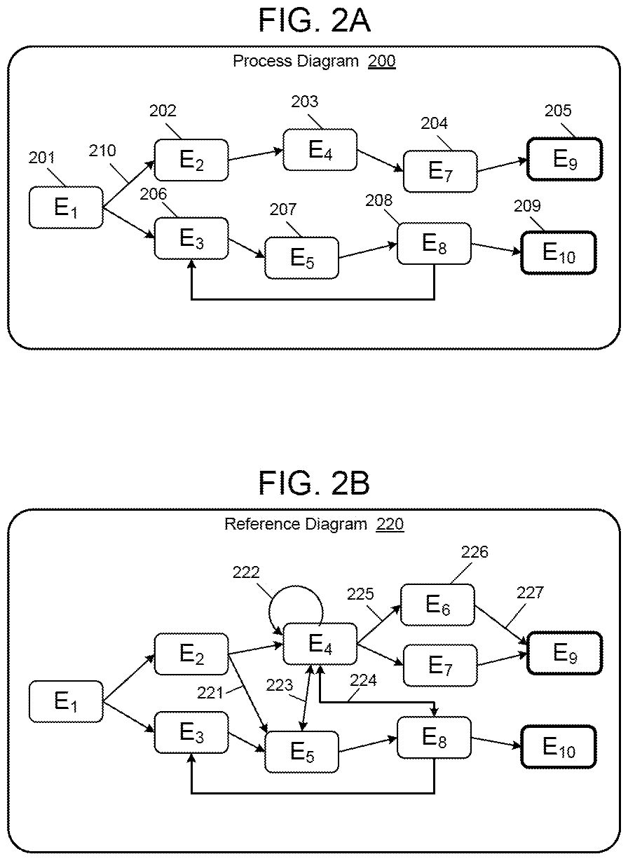

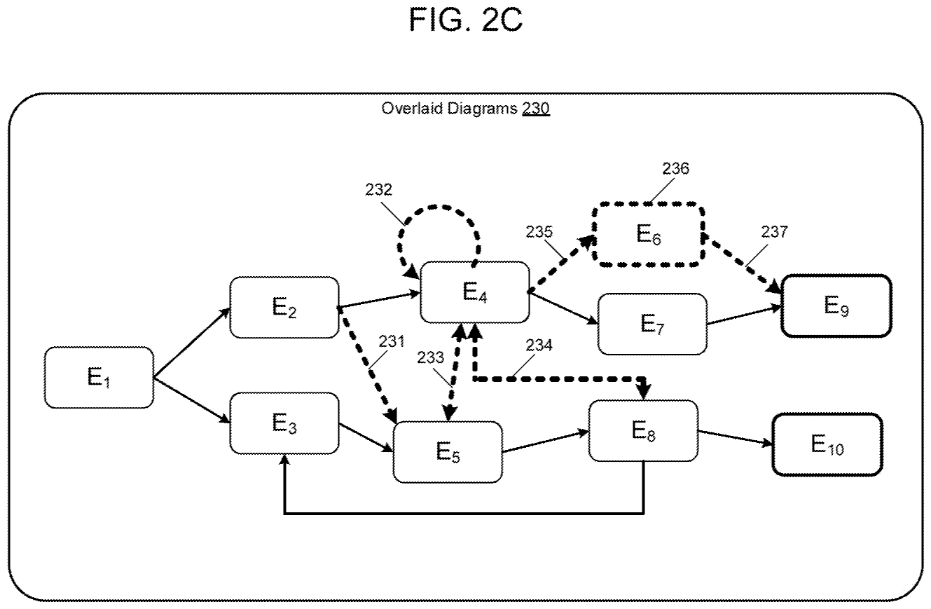

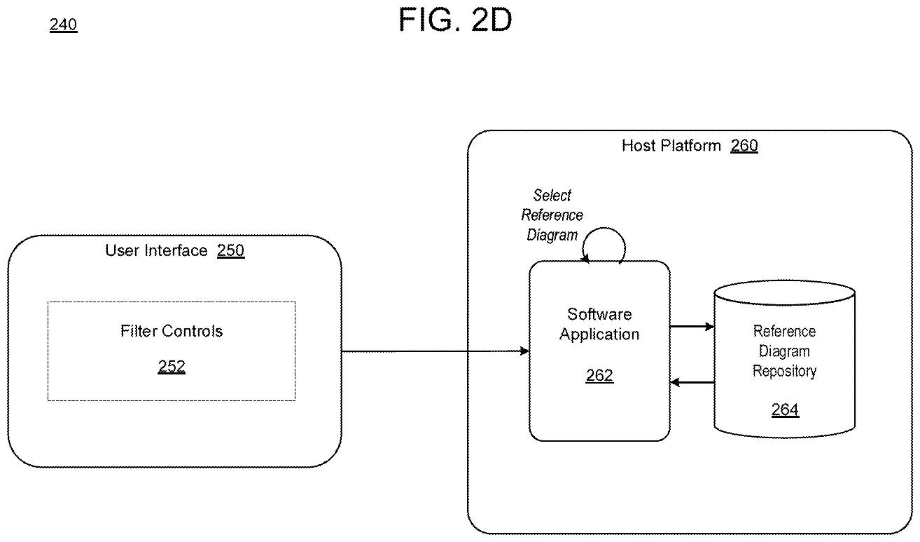

FIGS. 2A-2D illustrate a process of identifying a suggested improvement to a target process based on a reference diagram of a reference process in accordance with example embodiments. For example, FIG. 2A illustrates a process diagram 200 of a target process. The process diagram 200 may be generated from document data by the software application 122 described in the example of FIG. 1. The process diagram 200 includes a plurality of nodes including a node 201, a node 202, a node 203, a node 204, a node 205, a node 206, a node 207, a node 208, and a node 209 corresponding to a sequence of events that occur during execution of the target process and a plurality of edges 210 between the plurality of nodes which identify executional dependencies between the events. The process diagram 200 represents a current implementation of an organization's process. Further, a target process (more optimal process) can be derived based off of the benchmarking process described below.

FIG. 2B illustrates a reference diagram 220 (also referred to herein as a reference process) that is related to the target process shown in the process diagram 200. For example, the reference process may be the same type of process, but with a different sequences of steps, edges, nodes, etc. than the target process. The reference diagram 220 may be generated from a combination of process diagrams of a combination of other organizations that are within a dynamically-selected peer group. Based on the same logic as process mining for one customer project, the reference diagram can be constructed by overlaying the different traces of process instances observed in the systems of the other organizations. Thus, paths which are used by more of the selected peers will display more usage (e.g., via wider arrows between the activity nodes) while paths not used by this specific group will not be shown in this diagram. In particular, a filtering process as described in the examples of FIGS. 4A-4C can be performed to dynamically filter a large corpus of records corresponding to a large number of organizations down to a few records corresponding to a few organizations that are best in class in terms of performance that can be identified from the process diagrams such as timing, quantity, delays, and the like.

In the example of FIG. 2B, the reference diagram 220 includes the nodes 201-209 from the target process. In addition, the reference diagram also includes additional diagram parts including an edge 221, an edge 222, an edge 223, an edge 224, an edge 225, a node 226, and an edge 227. The reference diagram also includes edges therebetween that are from the reference process and which are not included in the target process. Based on process analyses using the same approach, the host platform 120 contains information about how other customers implemented their processes and, e.g., the edge 221 is used by 90% of the industry peers which execute the process 20% faster. The reference diagram 220 may be a copy of another process (such as of another organization) that has been identified as being a best-in-class process. As another example, the reference diagram 220 may be generated by combining steps of the process from multiple different process diagrams in the same field to build a complete model of the process.

The reference diagram 220 may be supplied by the user (organization) that also submits the process diagram 200. As another example, the reference diagram 220 may be identified by the host platform, such as by searching for the reference diagram 220 using a search interface as described in FIG. 2D. It should be appreciated that there is not limitation to how the reference diagram 220 is generated.

According to various embodiments, the system described herein may overlay the reference diagram 220 on top of the process diagram 200 to generate a visualization of steps that can be integrated into the process diagram 200 to help improve the execution of the target process corresponding to the process diagram 200. Furthermore, the system may remove steps to prevent the process from becoming more complicated and thereby simplifying the process. For example, FIG. 2C illustrates a process 240 of overlaying the reference diagram 220 on the process diagram 200 to generate a pair of overlaid diagrams 230 within a user interface of the software application. In this example, the overlaid diagrams 230 illustrate suggested recommendations that include an alternative data flow that includes a path 231, a path 232, a path 233, a path 234, a path 235, a node 236, and a path 237 within the target process by integrating the alternative data flow into the process diagram 200.

The overlaying process may integrate pieces of the reference diagram 220 into the process diagram 200. For example, the system may connect the path 235 between an existing node (E₄) of the process diagram 200 and a new node (E₆) in the reference diagram 220 as shown in FIG. 2C to visually show how the existing process can be modified to create the improvement.

Here, the software may distinguish the recommended changes (different data flow/steps) on the user interface from the existing flow of the target process using highlighting, bold lines, thicker lines, different colors, shading, and the like. As a result, a viewer can quickly see what changes to make to the target process based on the alternative data flow including a new node (e.g., the node 236) and new paths (e.g., the path 231, the path 232, the path 233, the path 234, the path 235, the node 236, and the path 237). Additional recommendations could be to focus the execution on these new paths instead of continuing to execute, e.g., paths including node E3.

FIG. 2D illustrates a process 240 of a user interacting with a user interface 250 for searching for a reference diagram in accordance with an example embodiment. For example, a host platform 260 may host a software application 262 which carries out the benchmarking process described in the example embodiments. The software application 262 may include or otherwise have access to a repository 264 of process diagrams of other organizations, reference diagrams, target process diagrams, and the like. The software application 262 may also combine multiple process diagrams of multiple organizations in the same class to generate a reference diagram for the class. The parameters of the class can be configured by the user by selecting filtering attributes and conditions via controls 252 on the user interface 250 which can be submitted to the software application 262.

Based on process performance metrics collected and derived for each different version of the process diagram customers might have implemented, customers can query the system to display the flow(s) associated with the best results when it comes to, e.g., completion rate, overall execution time or least manual effort. Since each customer might have optimized for different performance metrics, the customer can inspect which ones are most promising and easiest to adapt when overhauling their own processes. This, of course, needs to ensure anonymity of customers, e.g., by never displaying individual models but only aggregates of the top N customers for a metric.

In some embodiments, the software application 262 may manage an index of information about the reference diagrams that are stored in the repository 264. For example, each diagram may have a set of fields with data values stored therein which identify attributes of the reference process such as KPIs including but not limited to revenue, number of employees, sales, spending on lead generation, spending on procurement, number of customers, and the like. The software application 262 may compare the filtering conditions input via the controls 252 to identify a reference diagram with a description that most closely matches the search input. As another example, the software application 262 may identify a plurality of organizations/process diagrams that meet all filtering criteria entered via the controls 252, and build a reference diagram from the plurality of process diagrams of the plurality of organizations. Here, the reference diagram may include every possible step (e.g., a maximum of all steps) combined across the plurality of process diagrams from the plurality of organizations, while the target process is usually only a subset of the steps.

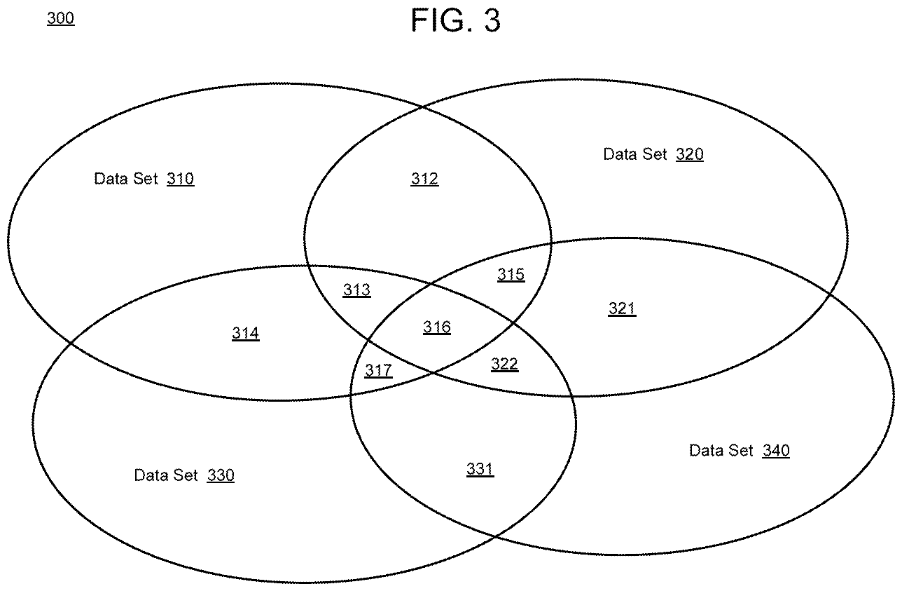

FIG. 3 illustrates a logical view 300 of partially overlapping data sets including a data set 310, a data set 320, a data set 330, and a data set 340 in accordance with example embodiments. Referring to FIG. 3, the partially overlapping data sets may correspond to a plurality of sets of data records which can be filtered using filtering conditions that are input via a user interface. In the example of FIG. 3, the data set 310 shares a subset of data 312 with only the data set 320. In addition, the data set 310 shares subsets of data 313, 315, 316, and 317 with the data set 320, and other data sets. Furthermore, the data set 310 also shares a subset of data 314 with only the data set 330. Other subsets of data can be found therein including a subset of data 321 that is shared by only the data set 320 and the data set 340, a subset of data 322 shared between the data set 320, the data set 330, and the data set 340, and a subset of data 331 shared between the data set 330 and the data set 340.

If, for example, data set 310 contains attributes such as “revenue last year” and “profit margin” for 100,000 companies, a customer filtering only for attributes from this data set can potentially be compared to any of these 100,000 companies. Further, if data set 320 contains employee information and headquarter locations of 50,000 companies, a customer who filters for attributes in data set 310 (revenue) and in data set 320 (employee count) can only be compared to customers who are present in both data sets (i.e., the intersection created by the subset of data 312). Thus, the more sub-data sets are available, the smaller the intersections between all involved data sets might be and, consequently, the smaller the candidate set of potential peers who match the filters chosen. One publicly available example for such a data set are the filings with the Security and Exchange Committee (SEC) from companies publicly traded in the United States. This data set may contain several company attributes that customers are very interested in for filtering purposes. Identifying the same company throughout each data set can be achieved by different means (depending on availability) ranging from unique tax identification numbers in the US and other regions, the name of the entity, the stock symbol or any globally unique classification scheme for companies such as the DUNS number.

In the example embodiments, filtering mechanism can be used to filter through the different sets of data records (e.g., tables, files, documents, etc.) and the different subsets of the data records using different filtering criteria. FIGS. 4A-4C are diagrams illustrating a filtering process that is performed based on user interaction with a user interface. Through the user interface, the user can filter the data records (e.g., the organizational records) based on key performance indicators (KPIs) of interest to the user with respect to a target process of the user. For example, the user may select a KPI such as “revenue” and a condition such as “greater than 500M” and query a database of data records for all data records that satisfy the condition of the selected KPI. The user can also chain together filtering conditions to further reduce the number of data records that match all filtering criteria. When the user has reached a target or desired number of data records as a result of the filtering, the user may perform another operation such as select to have a reference diagram created, select to have a key performance indicator (KPI) KPIs created, select to have a process performance indicator created, or the like.

In the example embodiments, the user interface is “interactive” and sequential in that the filtering process occurs based on user interactions and the filtering may be performed such that multiple filters are applied in sequence. When a first filtering condition is applied (e.g., number of employees greater than 10,000, etc.), the system may compare the filtering condition to a value that is stored in each of the data records such as a value for current number of employees of the organization which is stored within a predefined field, row, column, etc. of the data records. The comparison may be performed for each organization resulting in some organizations that satisfy the condition (a first subset) and some that don't (a second subset). Additional filtering conditions can be applied to the first subset of data records to further refine the records.

Traditionally, a filtering operation simply performs a value comparison without much insight into the remaining content within the data records. In the example embodiments, the user interface may provide transparency into the future filtering operations to be performed on the data records by displaying information about the additional filtering conditions available for the subset of data records and the number of data records that satisfy the filtering conditions.

For example, FIG. 4A illustrates a process 400 of filtering a set of data records 412 within a data store 410, such as a database. The set of data records 412 may correspond to a set of organizations, respectively. Here, by filtering the set of data records 412 the system also filters the organizations associated the data records. In this example, the filtering is performed by a software application 420 hosted by a host platform (not shown). Here, the software application 420 includes a filter processor 422 that can receive filter conditions and analyze fields of data within the set of data records 412 to determine whether the set of data records 412 are match to the filter conditions. The conditions may be selected via a user interface 430 of the software application 420 which includes controls for filtering the set of data records 412.

For example, in FIG. 4A, the user interface 430 includes a plurality of boxes 431 corresponding to a plurality of filter attributes 432 also referred to herein as dimensions. Each attribute can be selected and used to filter the set of data records 412. In this example, the user has selected two attributes (Revenue and No. of Customers). In some embodiments, this may be enough to complete the search process. As another example, the user may establish weights for the different attributes and even set values or ranges of values corresponding to filter conditions. For example, the user may select a link 433 to set a weight for the Revenue attribute with respect to the other filtering attributes. As another example, the user may select a link 434 to set an attribute value/condition for the filtering process.

FIG. 4B illustrates a process 400B of the user setting a weight for the Revenue attribute via an input mechanism 435. For example, the user may use a pointer such as a finger, a mouse keyboard commands, speech, etc., to select the link 433 in the user interface 430 shown in FIG. 4A to cause the user interface to change to a user interface 430b shown in FIG. 4B. Here, the user may move the cursor and hover over the input mechanism 435, etc. Furthermore, the user may click/press on the input mechanism 435 based on the cursor and drag the input mechanism in one of two directions to change a weight value for the attribute. The value that is selected via the user interface 430b may be delivered to the filter processor 422 and used to filter the set of data records 412 within the data store.

FIG. 4C illustrates a process 400C of setting a value or a range of values for the attribute Revenue based on user inputs on the user interface. In this example, the user may use the cursor to select the link 434 shown on the user interface 430 in FIG. 4A to cause the user interface to change to user interface 430c shown in FIG. 4C. In this example, the user interface 430c initializes a box 436 with input fields 437 and 438 for establishing a range of values to be used with the attribute when filtering the set of data records 412.

However, it should be appreciated that the user may not enter a value for the attribute into the filtering criteria. Instead, the system may automatically use a value of the target process for the filtering criteria. For example, if the target process is associated with a process that has 30M in revenue, then the system may automatically set the filter criteria for a similar range of revenue, for example, 20-40M, etc., thereby ensuring that the minimal amount of companies is still present in the benchmarking peer group.

FIG. 5A-5B illustrate a process of the user interface changing based on user inputs to a user interface in accordance with example embodiments. For example, assume that a user uses the user interface 430c shown in FIG. 4C to set a revenue value of greater than 500M. In other words, the user has input search criteria to find all organizations where the revenue value is greater than 500M based on values for revenue of the organizations stored in the data records within the data store. In response, the system may execute a filtering then perform a process 500 of displaying the results of the filtering via a user interface 530 as shown in FIG. 5A. Referring to FIG. 5A, the filter processor 422 identifies 2,764 data records (organizations) that have a first filtering condition 531 (i.e., a revenue of more than 500M) which is displayed on the user interface 530. An identifier of total number of data records matching the first filtering condition 531 is displayed within a field 532 on the user interface 530.

According to various embodiments, the software application 420 may also provide additional filtering criteria for the matched records within the field 532. Here, the software application 420 may render additional fields 533, 534, 535, etc. with additional filtering options for the remaining data records (organizations) within the subset of data records. That is, the filtering options correspond to the identifier data records displayed in the field 532. In this example, the additional fields 533, 535, and 535 with the additional filtering options may be displayed in parallel to each other vertically on the user interface. Furthermore, the filtering options may each be displayed in sequence to the field 532 horizontally thereby enabling the user to understand the each of the additional filtering options within the additional fields 533, 534, and 535 corresponds to the data records in the field 532.

By providing the user with the additional filtering options, the user obtains more than just the results of the filtering process but also additional insight and information that can be used during a next iteration of the filtering process.

For example, FIG. 5B illustrates a process 500B of displaying the results of a second filtering condition 541 on the user interface causing a change from the user interface 530 to the user interface 530b in FIG. 5B. Here, the second filtering condition 541 (i.e., number of customer less than 20,000) is applied to the data records in combination with the previously executed filtering condition (i.e., the first filtering condition 531) by the filer processor. In this example, the data records shown in the field that satisfy the first filtering condition 531 are further filtered based on the second filtering condition 541 resulting in an additional subset 542 of data records. Furthermore, the software application 420 may analyze the content within the additional subset 542 of data records and determine additional filtering conditions 543, 544, 545, etc. The additional filtering conditions may include data values and may include operations such as greater than, less than, equal to, not, etc. As another example, the data values may be used from the target process.

In this example, the host system provides transparency into the remaining data records and also to the possible filtering options that can be used to further filter the remaining data records. In this way, the system can guide the user through the filtering process while providing significantly more transparency to the underlying data being searched than traditional search mechanisms and search engines. The transparency enables a user to find what they are looking for in less time.

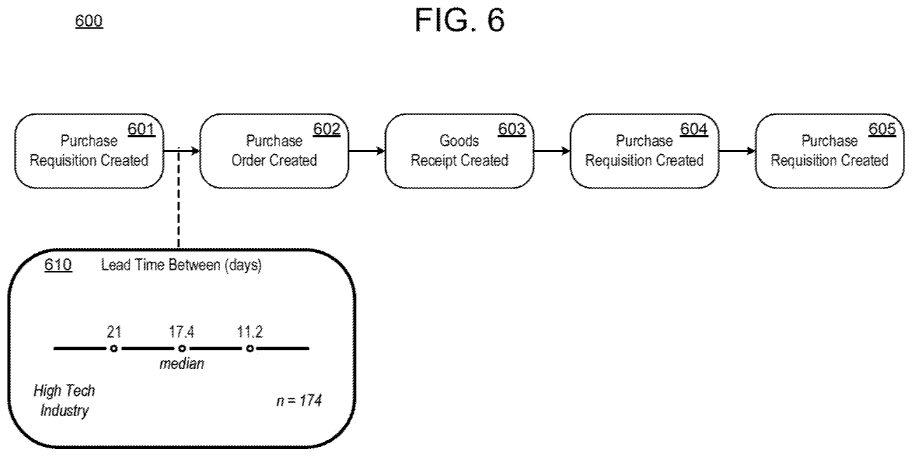

The dynamic peer grouping process that is performed herein can be used to select a group of records from comparison to a customer's record. As an example, the dynamic peer grouping process may be used to identify other organizations (peers) with related process graphs. As another example, the dynamic peer grouping process may be used to identify other organizations (peers) for use in comparing other attributes such as key performance indicators (KPIs), process performance indicators (PPIs), and the like. For example, FIG. 6 illustrates a diagram 600 with a sequence of steps that are part of a process. The diagram includes step 601, step 602, step 603, step 604, and step 605. The steps are performed in sequence.

In this example, a user may use the peer grouping process described herein to dynamically select a group of peers to be used to compare PPIs such as lead time between two steps in the process (i.e., the step 601 and the step 602). In response, the system may display a window 610 within details about lead times of the peers that are included in the dynamically selected benchmarking group.

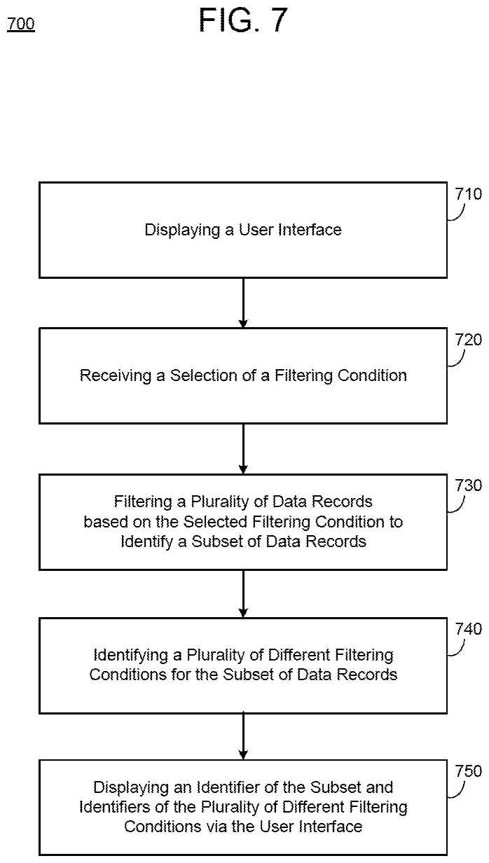

FIG. 7 illustrates a method 700 of controlling a record filtering process via a user interface in accordance with example embodiments. For example, the method 700 may be performed by a software application hosted by a host platform such as a cloud platform, a web server, a distributed system, a database, or the like. Referring to FIG. 7, in 710, the method may include displaying a user interface comprising interactive controls. In 720, the method may include receiving a selection of a filtering condition from among a plurality of filtering conditions based on input on an interactive control on the user interface.

In 730, the method may include, in response to the receipt of the selection, filtering a plurality of data records based on the selected filtering condition to identify a subset of data records that satisfy the filtering condition from among the plurality of data records. In 740, the method may include identifying a subset of filtering conditions from among the plurality of filtering conditions that are available for the subset of data records. In 750, the method may include displaying an identifier of the subset of data records and identifiers of the subset of filtering conditions on the user interface. Although not shown in FIG. 7, the method may also include displaying the benchmarks of the dynamic peer group.

In some embodiments, the displaying the identifier comprises displaying a bubble with an identifier of the subset of data records inside the bubble, and displaying bubbles with identifiers of the subset of filtering conditions inside the bubbles, respectively. In some embodiments, the displaying the identifier may further include displaying the bubble with the identifier of the subset of data records in parallel to the bubbles with the identifiers of the subset of filtering conditions on the user interface. In some embodiments, the method may further include determining an amount of data records within the subset of data records that satisfy an additional filtering condition, and the displaying comprises displaying an identifier of the additional filtering condition and the determined amount of data records that satisfy the additional filtering condition next to the identifier of the subset of data records within the user interface.

In some embodiments, the plurality of data records may correspond to a plurality of organizations, and the plurality of filtering conditions correspond to a plurality of organizational metrics. In some embodiments, the method may further include displaying a sub-menu with identifiers of the plurality of filtering conditions and a plurality of controls for selecting the plurality of filtering conditions, respectively, and the receiving the selection of the filtering condition comprises receiving a selection of a control within the sub-menu which selects a filtering condition from among the plurality of filtering conditions. In some embodiments, the receiving may include receiving a selection of a sequence of filtering conditions, and executing the sequence of filtering conditions in sequence on the plurality of data records to identify the subset of data records.

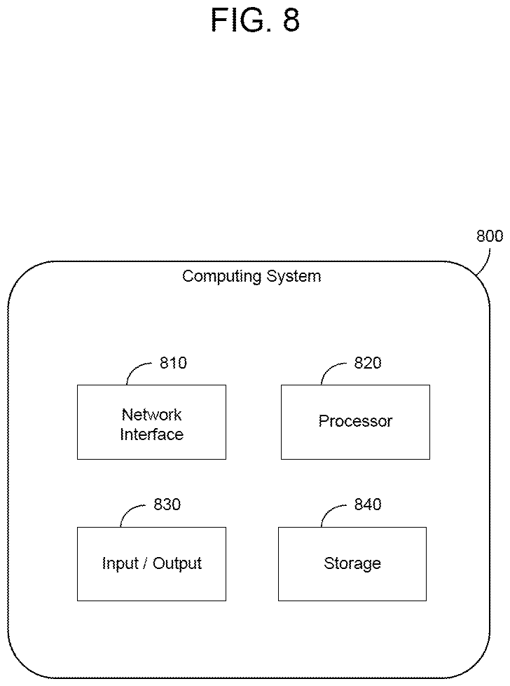

FIG. 8 illustrates a computing system 800 that may be used in any of the methods and processes described herein, in accordance with an example embodiment. For example, the computing system 800 may be a database node, a server, a cloud platform, or the like. In some embodiments, the computing system 800 may be distributed across multiple computing devices such as multiple database nodes. Referring to FIG. 8, the computing system 800 includes a network interface 810, a processor 820, an input/output 830, and a storage 840 such as an in-memory storage, and the like. Although not shown in FIG. 8, the computing system 800 may also include or be electronically connected to other components such as a display, an input unit(s), a receiver, a transmitter, a persistent disk, and the like. The processor 820 may control the other components of the computing system 800.

The network interface 810 may transmit and receive data over a network such as the Internet, a private network, a public network, an enterprise network, and the like. The network interface 810 may be a wireless interface, a wired interface, or a combination thereof. The processor 820 may include one or more processing devices each including one or more processing cores. In some examples, the processor 820 is a multicore processor or a plurality of multicore processors. Also, the processor 820 may be fixed or it may be reconfigurable. The input/output 830 may include an interface, a port, a cable, a bus, a board, a wire, and the like, for inputting and outputting data to and from the computing system 800. For example, data may be output to an embedded display of the computing system 800, an externally connected display, a display connected to the cloud, another device, and the like. The network interface 810, the input/output 830, the storage 840, or a combination thereof, may interact with applications executing on other devices.

The storage 840 is not limited to a particular storage device and may include any known memory device such as RAM, ROM, hard disk, and the like, and may or may not be included within a database system, a cloud environment, a web server, or the like. The storage 840 may store software modules or other instructions which can be executed by the processor 820 to perform the methods described herein. According to various embodiments, the storage 840 may include a data store having a plurality of tables, records, partitions and sub-partitions. The storage 840 may be used to store database records, documents, entries, and the like.

In some embodiments, the storage 840 may a data store that stores a plurality of data records. In this example, the processor 820 may be configured such that it displays a user interface comprising interactive controls, receives a selection of a filtering condition from among a plurality of filtering conditions based on input on an interactive control on the user interface, in response to the receipt of the selection, filters the plurality of data records based on the selected filtering condition to identify a subset of data records that satisfy the filtering condition from among the plurality of data records, identifies one or more additional filtering conditions for the subset of data records from among the plurality of filtering conditions, and displays an identifier of the subset of data records and identifiers of the one or more filtering conditions for the subset on the user interface.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, external drive, semiconductor memory such as read-only memory (ROM), random-access memory (RAM), and/or any other non-transitory medium.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

What is claimed is:

1. A computing system comprising:
a data store configured to store a plurality of data records; and
a processor configured to
display a user interface comprising interactive controls,
receive a selection of a filtering condition from among a plurality of filtering conditions based on input on an interactive control on the user interface,
in response to receipt of the selection, filter the plurality of data records based on the filtering condition to identify a subset of data records that satisfy the filtering condition from among the plurality of data records,
identify one or more additional filtering conditions for the subset of data records from among the plurality of filtering conditions, and
display an identifier of the subset of data records and identifiers of the one or more additional filtering conditions for the subset of data records on the user interface.

2. The computing system of claim 1, wherein the processor is configured to display a bubble with an identifier of the subset of data records inside the bubble, and display one or more additional bubbles with identifiers of the one or more additional filtering conditions inside a plurality of bubbles, respectively.

3. The computing system of claim 2, wherein the processor is configured to display the one or more additional bubbles with the identifiers of the one or more additional filtering conditions in parallel to the bubble with the identifier of the subset of data records on the user interface.

4. The computing system of claim 1, wherein the processor is further configured to determine an amount of data records within the subset of data records that satisfy an additional filtering condition, and display an identifier of the additional filtering condition and the determined amount of data records that satisfy the additional filtering condition next to the identifier of the subset of data records within the user interface.

5. The computing system of claim 1, wherein the plurality of data records correspond to a plurality of organizations, and the plurality of filtering conditions correspond to a plurality of organizational metrics.

6. The computing system of claim 1, wherein the processor is further configured to display a sub-menu with identifiers of the plurality of filtering conditions and a plurality of controls for selecting the plurality of filtering conditions, respectively, and receive a selection of a control within the sub-menu which selects a filtering condition from among the plurality of filtering conditions.

7. The computing system of claim 1, wherein the processor is configured to receive a selection of a sequence of filtering conditions, and execute the sequence of filtering conditions in sequence on the plurality of data records to identify the subset of data records.

8. A method comprising:
displaying a user interface comprising interactive controls;
receiving a selection of a filtering condition from among a plurality of filtering conditions based on input on an interactive control on the user interface;
in response to receipt of the selection, filtering a plurality of data records based on the filtering condition to identify a subset of data records that satisfy the filtering condition from among the plurality of data records;
identifying a subset of filtering conditions from among the plurality of filtering conditions that are available for the subset of data records; and
displaying an identifier of the subset of data records and identifiers of the subset of filtering conditions that are available for the subset of data records on the user interface.

9. The method of claim 8, wherein the displaying the identifier comprises displaying a bubble with an identifier of the subset of data records inside the bubble, and displaying bubbles with identifiers of the subset of filtering conditions inside the bubbles, respectively.

10. The method of claim 9, wherein the displaying the identifier further comprises displaying the bubble with the identifier of the subset of data records in parallel to the bubbles with the identifiers of the subset of filtering conditions on the user interface.

11. The method of claim 8, wherein the method further comprises determining an amount of data records within the subset of data records that satisfy an additional filtering condition, and the displaying comprises displaying an identifier of the additional filtering condition and the determined amount of data records that satisfy the additional filtering condition next to the identifier of the subset of data records within the user interface.

12. The method of claim 8, wherein the plurality of data records correspond to a plurality of organizations, and the plurality of filtering conditions correspond to a plurality of organizational metrics.

13. The method of claim 8, wherein the method further comprises displaying a sub-menu with identifiers of the plurality of filtering conditions and a plurality of controls for selecting the plurality of filtering conditions, respectively, and the receiving the selection of the filtering condition comprises receiving a selection of a control within the sub-menu which selects a filtering condition from among the plurality of filtering conditions.

14. The method of claim 8, wherein the receiving comprises receiving a selection of a sequence of filtering conditions, and executing the sequence of filtering conditions in sequence on the plurality of data records to identify the subset of data records.

15. A computer-readable storage medium comprising instructions which when executed by a processor cause a computer to perform:
displaying a user interface comprising interactive controls;
receiving a selection of a filtering condition from among a plurality of filtering conditions based on input on an interactive control on the user interface;
in response to receipt of the selection, filtering a plurality of data records based on the selected filtering condition to identify a subset of data records that satisfy the filtering condition from among the plurality of data records;
identifying a subset of filtering conditions from among the plurality of filtering conditions that are available for the subset of data records; and
displaying an identifier of the subset of data records and identifiers of the subset of filtering conditions on the user interface.

16. The computer-readable storage medium of claim 15, wherein the displaying the identifier comprises displaying a bubble with an identifier of the subset of data records inside the bubble, and displaying bubbles with identifiers of the subset of filtering conditions inside the bubbles, respectively.

17. The computer-readable storage medium of claim 16, wherein the displaying the identifier further comprises displaying the bubble with the identifier of the subset of data records in parallel to the bubbles with the identifiers of the subset of filtering conditions on the user interface.

18. The computer-readable storage medium of claim 15, wherein the computer is further configured to perform determining an amount of data records within the subset of data records that satisfy an additional filtering condition, and the displaying comprises displaying an identifier of the additional filtering condition and the determined amount of data records that satisfy the additional filtering condition next to the identifier of the subset of data records within the user interface.

19. The computer-readable storage medium of claim 15, wherein the plurality of data records correspond to a plurality of organizations, and the plurality of filtering conditions correspond to a plurality of organizational metrics.

20. The computer-readable storage medium of claim 15, wherein the computer is further configured to perform displaying a sub-menu with identifiers of the plurality of filtering conditions and a plurality of controls for selecting the plurality of filtering conditions, respectively, and the receiving the selection of the filtering condition comprises receiving a selection of a control within the sub-menu which selects a filtering condition from among the plurality of filtering conditions.
